(19) United States
(12) Patent Application Publication
(10) Pub. No.: US 2025/0392008 A1
(43) Pub. Date: Dec. 25, 2025

(54) ELECTRICITY STORAGE MODULE

(71) Applicant: Prime Planet Energy & Solutions, Inc., Tokyo (JP)

(72) Inventor: Yozo UCHIDA, Toyota-shi (JP)

(21) Appl. No.: 19/238,531

(22) Filed: Jun. 16, 2025

(30) Foreign Application Priority Data
Jun. 20, 2024 (JP) 2024-099429

(51) Int. Cl. H01M 50/503; H01M 50/507; H01M 50/517; H01M 50/522; H01M 50/553

(52) U.S. Cl. CPC H01M 50/503; H01M 50/507; H01M 50/517; H01M 50/522; H01M 50/553

(57) ABSTRACT

To provide a technology allowing a bus bar to be mounted more strongly on an electrode external terminal using a simpler structure. An electricity storage module disclosed herein includes aligned electricity storage device, and a bus bar. The bus bar has two non-through holes formed at the same surface of the bus bar. A positive electrode external terminal of one electricity storage device of the adjacent two electricity storage devices is fitted in one non-through hole of the two non-through holes, and a negative electrode external terminal of the other electricity storage device of the adjacent two electricity storage devices is fitted in the other non-through hole of the two non-through holes. By this, the bus bar forms the electrical connection between the adjacent two electricity storage devices.

### CROSS REFERENCE TO RELATED APPLICATIONS

The present application claims the priority based on Japanese Patent Application No. 2024-099429 filed on Jun. 20, 2024, the entire contents of which are incorporated in the present specification by reference.

### BACKGROUND OF THE DISCLOSURE

### 1. Field

The present disclosure relates to an electricity storage module.

### 2. Background

An electricity storage module including a secondary battery such as a lithium ion secondary battery is given as an example of an electricity storage module. Electricity storage modules of this type are being used in recent years, preferably for driving power sources for vehicles such as electric vehicles (BEV), hybrid vehicles (HEV), and plug-in hybrid vehicles (PHEV), for example.

Japanese Patent Application Publication No. 2016-85961 discloses a battery terminal including a shaft part, and a flange part extending in a radial pattern and in a radial direction from the shaft part. The battery terminal is composed of a cladding member with at least a first metal layer and a second metal layer joined to each other. Each of the shaft part and the flange part is composed of the first metal layer on one side and is composed of the second metal layer on the other side in an axis direction of the shaft part. The first metal layer at the shaft part has a portion projecting further toward the other side in the axis direction than a surface of the first metal layer at the flange part on the other side in the axis direction. This publication states that such a configuration allows the first metal layer and the second metal layer to be joined to each other with higher strength.

Japanese Patent Application Publication No. 2012-79456 discloses an assembled battery where an electrical cell having an electrode terminal is connected to an electrode terminal of a different electrical cell through an electrode terminal connection member. The electrode terminal is formed into a cone shape having a width dimension that decreases from a front end toward a battery container. The electrode terminal has a groove extending from the front end toward the battery container and dividing at least a portion of the front end into segmented portions, and a recessed portion formed at an outer peripheral surface thereof. The electrode terminal connection member has a fitting-hole to be fitted to the recessed portion by push-fitting the electrode terminal with the segmented portions at approximate positions into the fitting-hole. This publication states that such a configuration allows a state where the electrode terminal and the electrode terminal connection member are reliably connected to each other to be maintained for a long term.

Japanese Patent Application Publication No. 2015-49930 discloses a battery module including battery cells with substantially columnar positive electrode posts and negative electrode posts standing in a predetermined direction, and a conductive electrode connector forming connection between the positive electrode post and the negative electrode post of an adjacent battery cell. At the battery module, the battery cells juxtaposed to each other are connected in series through the electrode connector. The battery module includes openings provided at the electrode connector for allowing insertion of the positive electrode post and the negative electrode post therein. The battery module includes deforming means provided at either the positive electrode post and the negative electrode post or at the electrode connector and used for deforming portions of the opening facing the positive electrode post and the negative electrode post in a perpendicular direction substantially perpendicular to a predetermined direction. This publication states that such a configuration allows a state of connection between the adjacent battery cells to be ensured stably without damaging assemblability.

### SUMMARY

The present inventor desires to mount a bus bar more strongly on an electrode external terminal using a simpler structure.

According to a technology disclosed herein, an electricity storage module including electricity storage devices and a bus bar is disclosed. The electricity storage devices each include a case having rectangular first surfaces in a pair facing each other, and a positive electrode external terminal and a negative electrode external terminal provided on an outer surface of the case. The electricity storage devices are aligned in such a manner that the respective first surfaces of the electricity storage devices face each other. The bus bar is a member forming electrical connection between two of the electricity storage devices adjacent to each other in a direction in which the electricity storage devices are aligned. The bus bar has two non-through holes formed at the same surface of the bus bar. The positive electrode external terminal of one electricity storage device of the adjacent two electricity storage devices is fitted in one non-through hole of the two non-through holes, and the negative electrode external terminal of the other electricity storage device of the adjacent two electricity storage devices is fitted in the other non-through hole of the two non-through holes. By this, the bus bar forms the electrical connection between the adjacent two electricity storage devices. This configuration allows the bus bar to be mounted more strongly on the electrode external terminal using the simpler structure.

### BRIEF DESCRIPTION OF THE DRAWINGS

FIG. 1 is a perspective view of an electricity storage module 100;

FIG. 2 is a sectional view along II-II in FIG. 1;

FIG. 3 is a bottom view of a bus bar 14;

FIG. 4 is a sectional view of the bus bar 14; and

FIG. 5 is a graph showing a correlation between residual compressive force and a resistance value.

### DESCRIPTION OF THE EMBODIMENTS

Hereinafter, an embodiment of an electricity storage device disclosed here will be described. The embodiment described herein is not intended to specifically limit the technology disclosed herein. The technology disclosed herein is not limited to the embodiment described herein, unless otherwise stated. Each drawing is drawn schematically and does not necessarily reflect actual objects. Members or parts having the same function will be given the same reference signs as appropriate, and redundant description thereof may be omitted. In the drawings, reference signs “R,” “L,” “U,” “D,” “F,” and “Rr” denote “right,” “left,” “up,” “down”, “front,” and “rear” respectively. The notation “A to B” for a numerical range signifies “being equal to or greater than A and equal to or less than B,” and further encompasses the meaning of “being greater than A and less than B” unless otherwise mentioned.

In the present specification, an “electricity storage device” means a device to be charged and discharged by transfer of a charge carrier between a pair of electrodes (a positive electrode and a negative electrode) across an electrolyte. The electricity storage device encompasses: secondary batteries such as lithium ion secondary batteries, nickel-hydrogen batteries, and nickel-cadmium batteries; and capacitors such as lithium ion capacitors and electrical double-layer capacitors. The electricity storage device may be a lithium ion secondary battery, for example.

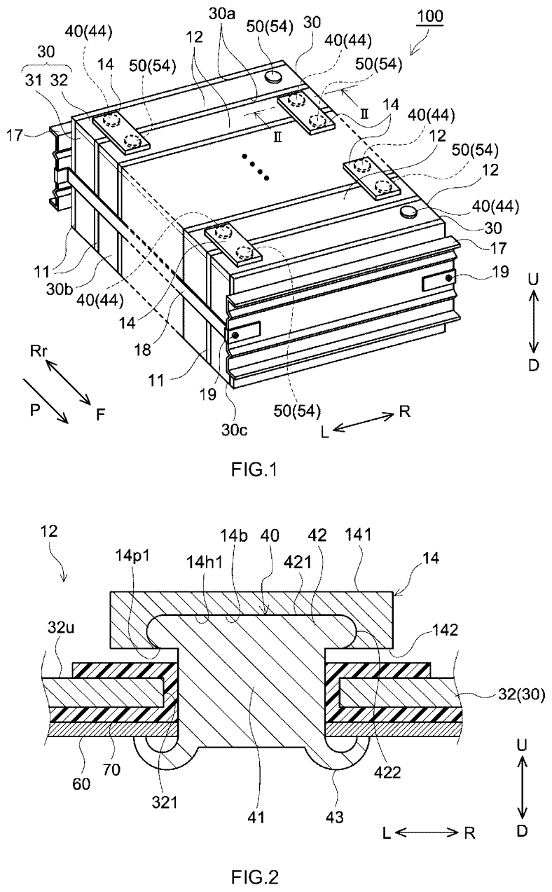

FIG. 1 is a perspective view of an electricity storage module 100. As shown in FIG. 1, the electricity storage module 100 includes electricity storage devices 12 and a bus bar 14. The electricity storage devices 12 are aligned in a first direction P. In a configuration shown in FIG. 1, the electricity storage device 12 includes a case 30 of a rectangular solid shape having first surfaces 30a in a pair facing each other, second surfaces 30b in a pair facing each other, and a bottom surface 30c. Here, the first surface 30a has a rectangular shape and is a largest-area surface of the case 30. As shown in FIG. 1, the first surfaces 30a in a pair facing each other extend from long sides in a pair facing each other of the bottom surface 30c. Here, the second surface 30b has a rectangular shape and is defined between the first surfaces 30a in a pair facing each other. As shown in FIG. 1, the second surfaces 30b in a pair facing each other extend from short sides in a pair facing each other of the bottom surface 30c. As shown in FIG. 1, the electricity storage devices 12 are aligned in such a manner that the respective first surfaces 30a face each other. The “first direction P” mentioned herein is a direction from one of the first surfaces 30a toward the other first surface 30a of the electricity storage device 12, and is a direction from the rear (Rr) side toward the front (F) side in FIG. 1.

The electricity storage device 12 includes the case 30, and an electrode body (not shown in the drawings) and an electrolyte solution (not shown in the drawings) housed in the case 30, for example. As shown in FIG. 1, the case 30 includes a main body 31 and a sealing plate 32. The main body 31 is a member housing the electrode body and the electrolyte solution, for example. Here, the main body 31 has a rectangular solid shape having an opening at one of its surfaces. In the configuration shown in FIG. 1, the main body 31 has the first surfaces 30a in a pair facing each other, the second surfaces 30b in a pair facing each other, and the bottom surface 30c. Here, the bottom surface 30c and the opening face each other. The sealing plate 32 is a member closing the opening of the main body 31, for example. The sealing plate 32 has a shape responsive to the opening of the main body 31, which is a rectangular shape (including a substantially rectangular shape, the same applies to the following) here. The sealing plate 32 has a first through hole 321 (see FIG. 2) and a second through hole (not shown in the drawings). Here, the first through hole 321 is a through hole for causing a positive electrode external terminal 40 to pass therethrough. Here, the second through hole is a through hole for causing a negative electrode external terminal 50 to pass therethrough. As the electrode body and the electrolyte solution of the electricity storage device 12, an electrode body and an electrolyte solution of an electricity storage device of this type (lithium ion secondary battery, for example) are available without any particular limitations.

FIG. 2 is a sectional view along II-II in FIG. 1. FIG. 2 shows a section of a connection and its vicinity in an enlarged manner between the bus bar 14 and the positive electrode external terminal 40. In this embodiment, the electricity storage device 12 includes the positive electrode external terminal 40 and the negative electrode external terminal 50 provided on an outer surface thereof. In the configuration shown in FIGS. 1 and 2, the electricity storage device 12 includes the positive electrode external terminal 40 and the negative electrode external terminal 50 provided on an upper surface 32u of the sealing plate 32. The positive electrode external terminal 40 is a member electrically connected to a positive electrode of the electrode body, for example. The positive electrode external terminal 40 passes through the first through hole 321, and has a part arranged in the case 30 and a part arranged outside the case 30. The part arranged in the case 30 is connected to the positive electrode of the electrode body. The part arranged outside the case 30 is connected to the bus bar 14 described later. The positive electrode external terminal 40 may be made of aluminum or an aluminum alloy, for example.

In this embodiment, the positive electrode external terminal 40 includes a shaft part 41, a flange part 42, and a swaged part 43. The shaft part 41 is a part passing through the first through hole 321 of the sealing plate 32, for example, and separates the positive electrode external terminal 40 into the part arranged in the case 30 and the part arranged outside the case 30. In this embodiment, the shaft part 41 has a columnar shape. As shown in FIG. 2, the swaged part 43 is provided at a lower end of the shaft part 41. The flange part 42 is provided at an upper end of the shaft part 41. In the configuration shown in FIG. 2, the part of the positive electrode external terminal 40 arranged in the case 30 corresponds to the swaged part 43. The part of the positive electrode external terminal 40 arranged outside the case 30 corresponds to the flange part 42.

The flange part 42 is a part connected to the bus bar 14, for example. Thus, the flange part 42 is arranged outside the case 30 as described above. In this embodiment, the flange part 42 has a disk shape extending around the shaft part 41. The flange part 42 has a diameter larger than the diameter of the shaft part 41, for example. In the configuration shown in FIG. 2, the flange part 42 is fitted in a first non-through hole 14h1 of the bus bar 14. Here, the flange part 42 is arranged in the first non-through hole 14h1. The swaged part 43 is a part connected to a positive electrode internal terminal 60, for example. Thus, the swaged part 43 is arranged in the case 30 as described above. In this embodiment, the swaged part 43 is a part formed by swaging the lower end of the shaft part 41 toward the positive electrode internal terminal 60.

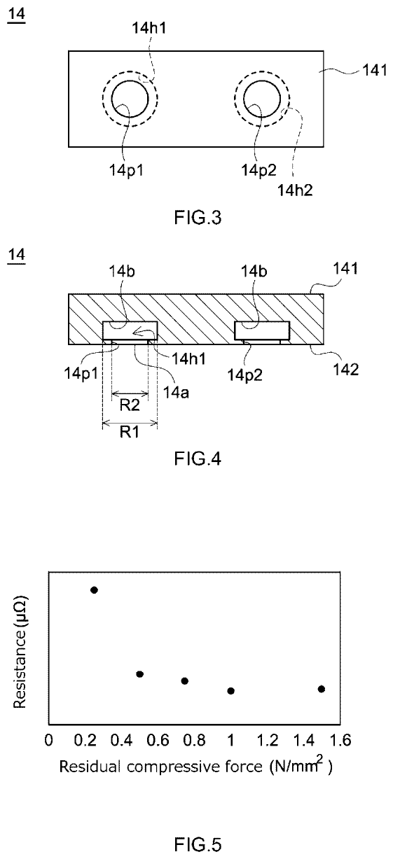

The negative electrode external terminal 50 may have the same configuration as the positive electrode external terminal 40. In this embodiment, the negative electrode external terminal 50 has a flange part (not shown in the drawings) fitted in a second non-through hole 14h2 (see FIGS. 3 and 4) of the bus bar 14. The flange part of the negative electrode external terminal 50 is arranged in the second non-through hole 14h2. Here, the description of the other configuration of the negative electrode external terminal 50 is omitted. The negative electrode external terminal 50 may be made of copper or a copper alloy, for example.

As shown in FIG. 2, the electricity storage device 12 includes an insulating member 70. The insulating member 70 is a member providing insulation between the bus bar 14, the sealing plate 32, the positive electrode external terminal 40, and the positive electrode internal terminal 60, for example. In this embodiment, the insulating member 70 is arranged between the bus bar 14 and the sealing plate 32, between the flange part 42 and the sealing plate 32, between the shaft part 41 and the sealing plate 32 (in FIG. 2, an inner wall of the first through hole 321), and between the sealing plate 32 and the positive electrode internal terminal 60. As the insulating member 70, an insulating member of an electricity storage device of this type (lithium ion secondary battery, for example) is available without any particular limitations. While not shown in the drawings, the electricity storage device 12 further includes an insulating member on the negative electrode side similar to the insulating member 70.

The bus bar 14 is a member forming electrical connection between the two electricity storage devices 12 adjacent to each other, for example. As shown in FIG. 1, the bus bar 14 is bridged across the two electricity storage devices 12 adjacent to each other in the first direction P. In this embodiment, the bus bar 14 is bridged across the positive electrode external terminal 40 of one electricity storage device 12 of the two electricity storage devices 12 adjacent to each other in the first direction P and the negative electrode external terminal 50 of the other electricity storage device 12.

FIG. 3 is a bottom view of the bus bar 14. FIG. 4 is a sectional view of the bus bar 14. FIG. 3 shows the configuration of a lower surface 142 of the bus bar 14. As shown in FIG. 2, in this embodiment, a surface of the bus bar 14 closer to the electricity storage device 12 is defined as the lower surface 142, and a surface thereof on the opposite side to the lower surface 142 is defined as an upper surface 141. As shown in FIGS. 3 and 4, the bus bar 14 has the first non-through hole 14h1 and the second non-through hole 14h2 formed at the lower surface 142. The first non-through hole 14h1 is a part in which the positive electrode external terminal 40 is fitted, for example. The second non-through hole 14h2 is a part in which the negative electrode external terminal 50 is fitted, for example. In this embodiment, the positive electrode external terminal 40 of one electricity storage device 12 of the two electricity storage devices 12 adjacent to each other in the first direction P is fitted in the first non-through hole 14h1, and the negative electrode external terminal 50 of the other electricity storage device 12 is fitted in the second non-through hole 14h2.

As shown in FIGS. 2 and 4, the first non-through hole 14h1 has an opening part 14a and a bottom part 14b on the side of the lower surface 142. In the configuration shown in FIGS. 2, 3, and 4, the first non-through hole 14h1 has a projection 14p1 provided on an inner wall thereof. As shown in FIGS. 3 and 4, the projection 14p1 is provided continuously in a circumferential direction of the first non-through hole 14h1. As shown in FIGS. 2 and 4, the projection 14p1 is provided along a peripheral edge of the opening part 14a.

As shown in FIG. 2, an edge of the positive electrode external terminal 40 is arranged closer to the bottom part 14b of the first non-through hole 14h1 than to the projection 14p1. In the configuration shown in FIG. 2, the flange part 42 of the positive electrode external terminal 40 is arranged closer to the bottom part 14b of the first non-through hole 14h1 than to the projection 14p1. Here, an upper end surface 421 of the flange part 42 is in contact with the bottom part 14b. A side surface 422 of the flange part 42 is in contact with the inner wall of the first non-through hole 14h1.

As shown in FIG. 4, a diameter R2 in an area of the first non-through hole 14h1 in the presence of the projection 14p1 (in this embodiment, the diameter R2 of the opening part 14a) is smaller than a diameter R1 in an area of the first non-through hole 14h1 without the projection 14p1 (in this embodiment, the diameter R1 of the bottom part 14b). While no particular limitations are imposed, with the diameter R1 defined as 1, the diameter R2 is from 0.8 to 0.99, for example, preferably from 0.85 to 0.97, more preferably from 0.9 to 0.95, from the viewpoint of retaining the positive electrode external terminal 40 more stably in the first non-through hole 14h1. With the diameter of the flange part 42 defined as 1, the diameter R1 is from 0.9 to 1.1, preferably, from 0.95 to 1.05, more preferably, from 0.95 to 1.0 or from 0.95 to 0.99, for example, from the viewpoint of providing better electrical connectivity between the positive electrode external terminal 40 and the bus bar 14.

In this embodiment, residual compressive force applied from the first non-through hole 14h1 toward the flange part 42 of the positive electrode external terminal 40 is set to a value greater than 0.3 N/mm². From the viewpoint of improving electrical connectivity between the bus bar 14 and the positive electrode external terminal 40, the residual compressive force may be equal to or greater than 0.4 N/mm², preferably equal to or greater than 0.5 N/mm², more preferably equal to or greater than 0.6 N/mm², still more preferably equal to or greater than 0.7 N/mm², particularly preferably equal to or greater than 0.8 N/mm². While no particular limitations are imposed, the residual compressive force may be approximately equal to or less than 2 N/mm² and is equal to or less than 1.8 N/mm², for example, preferably, equal to or less than 1.6 N/mm². Such residual compressive force can be fulfilled by setting a dimensional relationship between the diameter R1, the diameter R2, and the diameter of the flange part 42 of the positive electrode external terminal 40, for example. A relationship of the dimensional relationship between the diameter R1, the diameter R2, and the diameter of the flange part 42 of the positive electrode external terminal 40 with the residual compressive force is settable through CAE (Computer Aided Engineering) analysis, for example.

As an example, the first non-through hole 14h1 may be formed using a cutting machine (e.g. machining center) including a cutting tool (e.g. end mill) used for purposes of the same type. The projection 14p1 of the first non-through hole 14h1 may also be formed using such a cutting machine, for example.

The bus bar 14 is made of aluminum or an aluminum alloy, for example. From the viewpoint of fulfilling the effect of the technology disclosed herein more favorably, the bus bar 14 is preferably made of pure aluminum, for example. More preferably, the bus bar 14 is made of pure aluminum, and is composed of an O material subjected to annealing (such as A1050-O material or A1070-O material, for example). In this embodiment, a material made of a constituent element containing aluminum having a mass percentage of equal to or greater than 70% and less than 90% is called an “aluminum alloy,” a material made of a constituent element containing aluminum having a mass percentage of equal to or greater than 90% is called “aluminum,” and particularly, a material made of a constituent element containing aluminum having a mass percentage of 99% is called “pure aluminum.”

This also applies to copper. In this embodiment, a material made of a constituent element containing copper having a mass percentage of equal to or greater than 70% and less than 90% is called a “copper alloy,” a material made of a constituent element containing copper having a mass percentage of equal to or greater than 90% is called “copper,” and particularly, a material made of a constituent element containing copper having a mass percentage of 99% is called “pure copper.”

As shown in FIG. 1, in the electricity storage module 100, the electricity storage devices 12 are restrained in the first direction P. The electricity storage module 100 includes a spacer 11 and a pair of end plates 17. The spacer 11 is arranged between the electricity storage device 12 and the electricity storage device 12 adjacent to each other in the first direction P. The end plates 17 are arranged at both ends of the electricity storage devices 12 aligned in the first direction P respectively to restrain the electricity storage devices 12. The end plates 17 are bridged to each other with a metallic restraint band 18. An end portion of the restraint band 18 is fixed with a screw 19.

The electricity storage module 100 is used for various of purposes, and particularly, available preferably as a motor power source (driving power source) to be mounted on vehicles such as passenger cars and trucks. While a vehicle type is not particularly limited, preferred examples thereof include plug-in hybrid vehicles (PHEV), hybrid vehicles (HEV), and electric vehicles (BEV).

As described above, the electricity storage module 100 includes the electricity storage devices 12 and the bus bar 14. The electricity storage devices 12 each include the case 30 having the rectangular first surfaces 30a in a pair facing each other, and the positive electrode external terminal 40 and the negative electrode external terminal 50 provided on the outer surface of the case 30. The electricity storage devices 12 are aligned in such a manner that the respective first surfaces 30a of the electricity storage devices 12 face each other. The bus bar 14 is a member forming electrical connection between the two electricity storage devices 12 adjacent to each other in the first direction P in which the electricity storage devices 12 are aligned. The bus bar 14 has the two non-through holes (here, the first non-through hole 14h1 and the second non-through hole 14h2) formed at the same surface of the bus bar 14 (here, the lower surface 142). The positive electrode external terminal 40 of one electricity storage device 12 of the adjacent two electricity storage devices 12 is fitted in one non-through hole (here, the first non-through hole 14h1) of the two non-through holes, and the negative electrode external terminal 50 of the other electricity storage device 12 of the adjacent two electricity storage devices 12 is fitted in the other non-through hole (here, the second non-through hole 14h2) of the two non-through holes. By this, the bus bar 14 forms electrical connection between the adjacent two electricity storage devices 12.

In other words, in the electricity storage module 100, the positive electrode external terminal 40 of one electricity storage device 12 of the two electricity storage devices 12 adjacent to each other in the first direction P and the negative electrode external terminal 50 of the other electricity storage device 12 are fitted in respective ones of the two non-through holes provided at the bus bar 14, thereby establishing the electrical connection. The fit between the electrode external terminals and the non-through holes provided at the bus bar 14 allows the electrode external terminals and the bus bar 14 to be connected to each other more strongly. In addition, it becomes unnecessary to weld the electrode external terminals and the bus bar 14 to each other. Thus, it is possible for the bus bar 14 to be mounted more strongly on the electrode external terminal using the simpler structure.

The positive electrode external terminal 40 may include the shaft part 41, and the flange part 42 having a disk shape extending around the shaft part 41. At least the flange part 42 may be arranged in the first non-through hole 14h1. This achieves the fit more properly.

The first non-through hole 14h1 may have the projection 14p1 provided on the inner wall of the first non-through hole 14h1. The edge of the positive electrode external terminal 40 may be arranged closer to the bottom part 14b of the first non-through hole 14h1 than to the projection 14p1. This allows the first non-through hole 14h1 and the positive electrode external terminal 40 to be fitted to each other more stably.

The projection 14p1 may be provided continuously in the circumferential direction of the first non-through hole 14h1. This makes it possible to form the fit more stably.

Residual compressive force applied from the first non-through hole 14h1 toward a part of the positive electrode external terminal 40 (here, the flange part 42) arranged in the first non-through hole 14h1 may be greater than 0.3 N/mm². This achieves the fit more properly and allows reduction in a resistance between the bus bar 14 and the positive electrode external terminal 40.

The bus bar 14 may be made of pure aluminum containing aluminum having a percentage of equal to or greater than 99% of a constituent element. Pure aluminum is softer and easier to be subjected to treatment. By this, the bus bar 14 and the electrode external terminal can be fitted to each other more easily and preferable connection strength can be obtained more easily.

While the fit between the first non-through hole 14h1 of the bus bar 14 and the positive electrode external terminal 40 has been described above, fit between the second non-through hole 14h2 and the negative electrode external terminal 50 is formed in the same way. Thus, the fit on the negative electrode side is omitted here. The sign “14p2” in FIGS. 3 and 4 represents a projection provided at the second non-through hole 14h2.

One embodiment of the technology disclosed herein has been described above. The technology disclosed herein may include modifications and changes of the embodiment illustrated above as long as such modifications and changes allow achievement of the effect of the technology disclosed herein. For example, in the embodiment, the projection 14p1 is provided along the peripheral edge of the opening part 14a. However, a place of the projection may be changed as appropriate in response to the thickness of the flange part 42, for example. The projection may be provided between the opening part 14a and the bottom part 14b, for example. Furthermore, in the embodiment, the projection 14p1 is a part provided continuously in the circumferential direction of the first non-through hole 14h1. However, the shape of the projection is not limited to this. The inner wall of the first non-through hole 14h1 may be provided with projections, for example. These projections may be provided in a scattered pattern in the circumferential direction along the inner wall of the first non-through hole 14h1.

A test example relating to the technology disclosed herein will be described below. However, the technology disclosed herein is not intended to be limited to the following test example.

Two aluminum specimens were prepared. The aluminum specimens were A1050-O materials. The two aluminum specimens were overlaid on each other in such a manner as to contact each other in an area of 10 mm×10 mm. While load was applied to the overlaid portions of the two aluminum specimens using Autograph® (available from Shimadzu Cooperation), a resistance value (μΩ) between the specimens was measured. Then, CAE analysis was conducted on the basis of the measured data to obtain a correlation between residual compressive force (N/mm²) and the resistance value. Result thereof is shown in FIG. 5. FIG. 5 is a graph showing the correlation between the residual compressive force and the resistance value. FIG. 5 shows the correlation between the residual compressive force (N/mm²) between the two aluminum specimens described above (X axis) and the resistance value (μΩ) between the specimens (Y axis).

As shown in FIG. 5, significant resistance reduction was observed in a range where the residual compressive force between the two aluminum specimens is greater than 0.3 N/mm². In the configuration of the technology disclosed herein, it is possible for the bus bar to be connected more strongly on the electrode external terminal using the simpler structure, as described above. Furthermore, it was found from the result shown in FIG. 5 that, in addition to such effect, it is possible to reduce the resistance between the bus bar and the electrode external terminals by setting the residual compressive force appropriately to be applied from the non-through hole provided at the bus bar toward the electrode external terminals, for example.

The technology disclosed herein may include technologies described in the following articles.

Item 1:

An electricity storage module comprising:

electricity storage devices each including a case having rectangular first surfaces in a pair facing each other, and a positive electrode external terminal and a negative electrode external terminal provided on an outer surface of the case, the electricity storage devices being aligned in such a manner that the respective first surfaces of the electricity storage devices face each other; and

a bus bar forming electrical connection between two of the electricity storage devices adjacent to each other in a direction in which the electricity storage devices are aligned, wherein

the bus bar has two non-through holes formed at the same surface of the bus bar, and

the bus bar forms the electrical connection between the adjacent two electricity storage devices by fitting the positive electrode external terminal of one electricity storage device of the adjacent two electricity storage devices in one non-through hole of the two non-through holes and fitting the negative electrode external terminal of the other electricity storage device of the adjacent two electricity storage devices in the other non-through hole of the two non-through holes.

Item 2:

The electricity storage module according to Item 1, wherein the positive electrode external terminal and the negative electrode external terminal each include a shaft part, and a flange part having a disk shape extending around the shaft part, and at least the flange part is arranged in the non-through hole.

Item 3:

The electricity storage module according to Item 1 or 2, wherein the non-through hole has a projection provided on an inner wall of the non-through hole, and an edge of the positive electrode external terminal or an edge of the negative electrode external terminal is arranged closer to a bottom part of the non-through hole than to the projection.

Item 4:

The electricity storage module according to Item 3, wherein

the projection is provided continuously in a circumferential direction of the non-through hole.

Item 5:

The electricity storage module according to any one of Items 1 to 4, wherein

residual compressive force applied from the non-through hole toward a part of the positive electrode external terminal or a part of the negative electrode external terminal arranged in the non-through hole is greater than 0.3 N/mm².

Item 6:

The electricity storage module according to any one of Items 1 to 5, wherein

the bus bar is made of pure aluminum containing aluminum having a percentage of equal to or greater than 99% of a constituent element.

What is claimed is:

1. An electricity storage module comprising:
electricity storage devices each including a case having rectangular first surfaces in a pair facing each other, and a positive electrode external terminal and a negative electrode external terminal provided on an outer surface of the case, the electricity storage devices being aligned in such a manner that the respective first surfaces of the electricity storage devices face each other; and
a bus bar forming electrical connection between two of the electricity storage devices adjacent to each other in a direction in which the electricity storage devices are aligned, wherein
the bus bar has two non-through holes formed at the same surface of the bus bar, and
the bus bar forms the electrical connection between the adjacent two electricity storage devices by fitting the positive electrode external terminal of one electricity storage device of the adjacent two electricity storage devices in one non-through hole of the two non-through holes and fitting the negative electrode external terminal of the other electricity storage device of the adjacent two electricity storage devices in the other non-through hole of the two non-through holes.

2. The electricity storage module according to claim 1, wherein
the positive electrode external terminal and the negative electrode external terminal each include a shaft part, and a flange part having a disk shape extending around the shaft part, and
at least the flange part is arranged in the non-through hole.

3. The electricity storage module according to claim 1, wherein
the non-through hole has a projection provided on an inner wall of the non-through hole, and
an edge of the positive electrode external terminal or an edge of the negative electrode external terminal is arranged closer to a bottom part of the non-through hole than to the projection.

4. The electricity storage module according to claim 3, wherein
the projection is provided continuously in a circumferential direction of the non-through hole.

5. The electricity storage module according to claim 1, wherein
residual compressive force applied from the non-through hole toward a part of the positive electrode external terminal or a part of the negative electrode external terminal arranged in the non-through hole is greater than 0.3 N/mm².

6. The electricity storage module according to claim 1, wherein
the bus bar is made of pure aluminum containing aluminum having a percentage of equal to or greater than 99% of a constituent element.
